(19) United States
(12) Patent Application Publication
(10) Pub. No.: US 2007/0157317 A1
(43) Pub. Date: Jul. 5, 2007

(54) XML schema for service provisioning

(75) Inventors: Rajagopal K. Venkatachalam, Redmond, WA (US); Zeyong Xu, Issaquah, WA (US); Zhangwei Xu, Redmond, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/323,128

(22) Filed: Dec. 30, 2005

(51) Int. Cl. H04L 9/32

(52) U.S. Cl. 726/27

(57) ABSTRACT

An XML provisioning schema for provisioning and configuring a prepaid and/or a subscription based usage of a provisioned resource is used to communicate between a provisioning server and a client computer. The XML schema disclosed in here includes a content node containing content data identifying the service to be provisioned on the client computer and a signature node containing a signature of the content data. The XML provisioning server may generate an XML provisioning document using the XML provisioning schema, sign such an XML provisioning document using a key derived from a trusted root and communicate the XML provisioning document to the client computer using the provisioned resource.

### BACKGROUND

A large percentage of the world population cannot afford to own a computer and/or various software allowing an efficient use of the computer. There is a need to provide affordable access to computing to the populations of the developing countries. This is also true in light of the traditional structure of the software industry, where software licenses are generally sold on a perpetual license basis. As a result of not having enough resources to purchase perpetual licenses for the various software, people are also prohibited from using such software even on a short term basis for training purposes, etc. Moreover, even in the developed countries, when a computer user needs to use a particular software for a limited amount of time, the user is discouraged by the necessity to purchase a perpetual license for that particular software. One solution to get around this is to allow for provisioning of resource on client computers on a prepaid or subscription bases using provisioning servers.

When a provisioning server is used to provision a resource on a client computer, the provisioning server needs to communicate various information regarding the provisioned resource to the client computer. There are a number of different methods that may be used by the provisioning server to communicate such information to the client computer. One method of communicating such provisioning information is using the Internet. Generally speaking, the Internet is utilized to transmit and receive information in the form of web pages that are translated/interpreted and displayed by a web browser on a computer. Document definition languages are interpreted by web browsers and define how a document or information is to be displayed in the browser. Further, sets of rules, referred to as schemas, may provide for a particular structure of information.

So that a browser can interpret and display a web page, document definition languages and standard programming languages are utilized to define the web page. For example, hypertext markup language (HTML) is widely used to define web pages. However, HTML utilizes a predefined set of “tags” to describe elements on the web page. As a result, extensible markup language (XML) has become and is becoming more widely used on the internet. XML is more flexible than HTML and allows tags to be defined by the developer of the web page. XML provides a fairly complete set of tools for describing the parts of a document (elements), annotating those parts (attributes), and constraining the parts that can appear within the elements and attributes (content models and attribute types). Schemas use declarations to describe rules and constraints for elements and attributes, building a framework for documents out of a fairly small set of declarations. Declarations create a vocabulary and a set of constraints, identifying content and where it is to appear. Many schemas can be built using only a combination of element and attribute declarations, while other declarations (like entities and notations) can supplement these core declarations when needed in a particular situation.

Thus, a schema is a model for describing the structure of information. An XML schema describes a model for a whole class of documents. The model describes the possible arrangement of tags and text in a valid document. A schema may also be viewed as an agreement on a common vocabulary for a particular application that involves exchanging documents. In schemas, models are described in terms of constraints. A constraint defines what can appear in any given context. As described, there are basically two kinds of constraints: content model constraints and datatype or attribute constraints. Content model constraints describe the order and sequence of elements and datatype or attribute constraints describe valid units of data.

For using an XML packet to communicate provisioning information between a provisioning server and a client computer, it is necessary to define an XML schema that allows the provisioning server to easily build an XML provisioning packet and that allows the client computer to receive and interpret such a provisioning packet.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An XML provisioning schema for provisioning and configuring a prepaid and/or a subscription based usage of a provisioned resource is used to communicate between a provisioning server and a client computer. The XML schema disclosed in here includes a content node containing content data identifying the service to be provisioned on the client computer and a signature node containing a signature of the content data. The XML provisioning server may generate an XML provisioning document using the XML provisioning schema, sign such an XML provisioning document using a key derived from a trusted root and communicate the XML provisioning document to the client computer using the provisioned resource.

In an embodiment of the XML provisioning schema, the content node specifies at an amount of prepaid time for which the service is to be provisioned on the client computer or a subscription period expiry date through which the service is to be provisioned on the client computer. Additionally, the content node may also specify, among other things, a version of the provisioning XML document, date of creation of the provisioning XML document, time of creation of the provisioning XML document, hardware identification of the client computer; underwriter identification of the creator of the provisioning XML document; a sequence number of the provisioning XML document; a tracking identification of the provisioning XML document, etc.

### BRIEF DESCRIPTION OF DRAWINGS

The present patent is illustrated by way of examples and not limitations in the accompanying figures, in which like references indicate similar elements, and in which:

FIG. 1 is a block diagram of a network interconnecting a plurality of computing resources;

FIG. 2 is a block diagram of a computer that may be connected to the network of FIG. 1;

FIG. 3 is a block diagram of a provisioning system for provisioning a resource on a computer on the network of FIG. 1;

FIG. 4 is an exemplary illustration of an XML packet schema used for provisioning a resource on the computer on the network;

FIG. 5 is an exemplary illustration of an XML provisioning schema used for provisioning a resource on the computer on the network; and

FIG. 6 is an exemplary flowchart illustrating provisioning of a resource on a computer on the network.

### DETAILED DESCRIPTION

Although the following text sets forth a detailed description of-numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

### Network

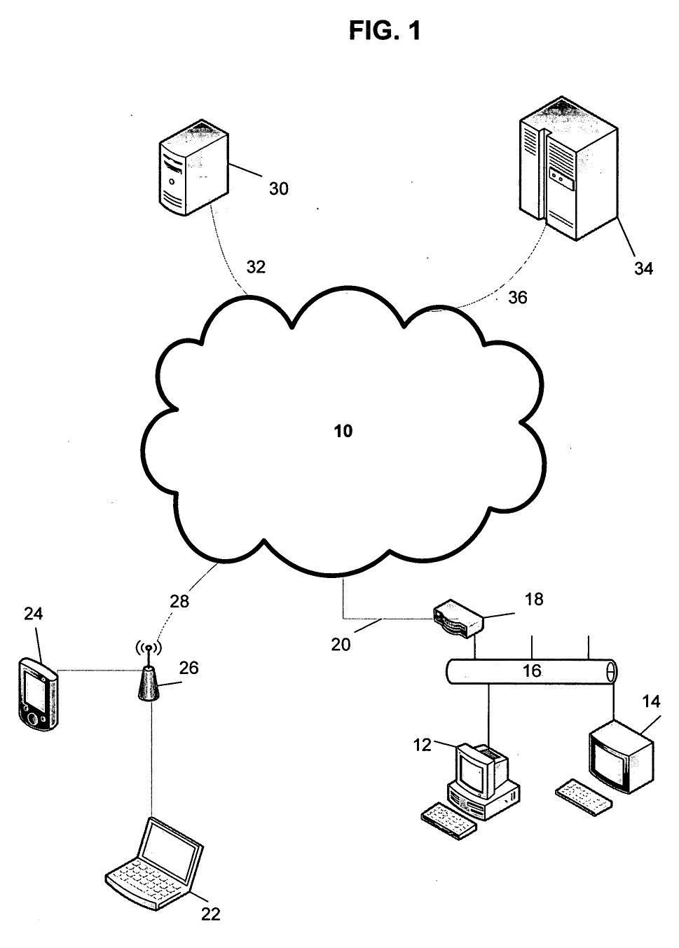

FIG. 1 illustrates a network 10 that may be used to implement a service provisioning system described herein. The network 10 may be the Internet, a virtual private network (VPN), or any other network that allows one or more computers, communication devices, databases, etc., to be communicatively connected to each other. The network 10 may be connected to a personal computer 12 and a computer terminal 14 via an Ethernet 16 and a router 18, and a landline 20. On the other hand, the network 10 may wirelessly connected to a laptop computer 22 and a personal data assistant 24 via a wireless communication station 26 and a wireless link 28. Similarly, a server 30 may be connected to the network 10 using a communication link 32 and a mainframe 34 may be connected to the network 10 using another communication link 36. As it will be described below in further detail, one or more components of the resource provisioning system may be stored and operated on any of the various devices connected to the network 10. For example, the resource provisioning system described in here may include a resource manager located on the mainframe 34 and various processes implemented on the personal computer 12.

### Computer

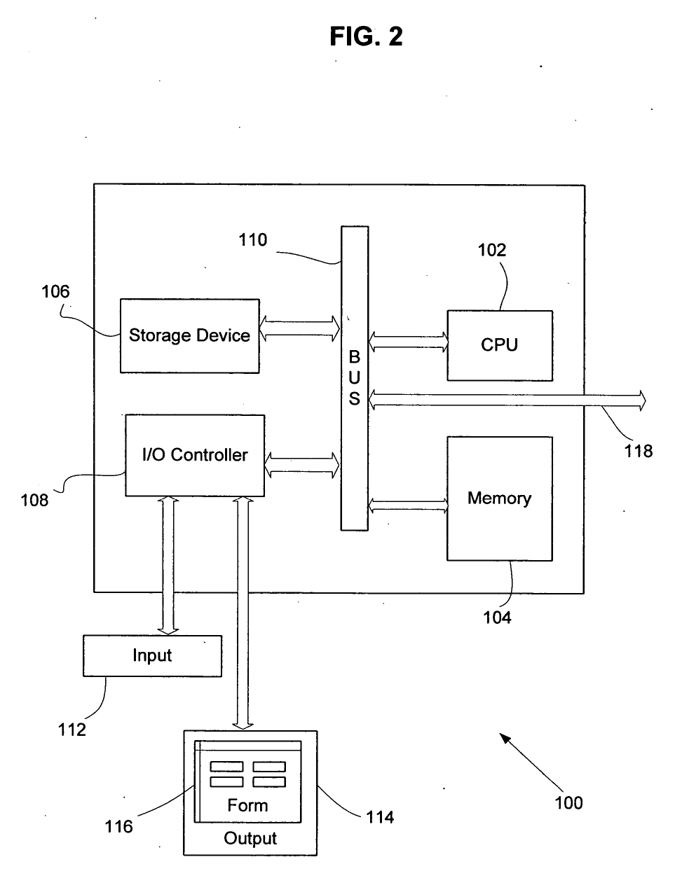

FIG. 2 illustrates a computing device in the form of a computer 100 that may be connected to the network 10 and used to implement one or more components of a resource provisioning system described herein. Components of the computer 100 may include, but are not limited to a central processing unit (CPU) 102, a memory 104, a storage device 106, an input/output controller 108, and a system bus 110 that couples various system components including the memory to the CPU 102. The system bus 110 may be any of several types of bus structures including a memory bus or memory controller, a peripheral bus, and a local bus using any of a variety of bus architectures.

The memory 104 may include computer storage media in the form of volatile and/or nonvolatile memory such as read only memory (ROM) and random access memory (RAM). A basic input/output system (BIOS), containing the basic routines that help to transfer information between elements within computer 110, such as during start-up, is typically stored in ROM. RAM typically contains data and/or program modules that are immediately accessible to and/or presently being operated on by processing unit 120. The memory 104 may also be used to store data related to one or more components and resources used by the computer 100.

The storage device 106 may typically include removable/non-removable, volatile/nonvolatile computer storage media. By way of example only, the storage device 106 may include a hard disk drive, a magnetic disk drive, nonvolatile magnetic disk 152, an optical disk drive, etc. One or more of the forms stored on the memory 104 may be populated using data stored on the storage device 106. The 1/0 controller may be used by the computer 100 to communicate with an input device 112, which may be a keyboard, a mouse, etc., an output device 114, which may be a monitor, a printer, etc.

### Provisioning System

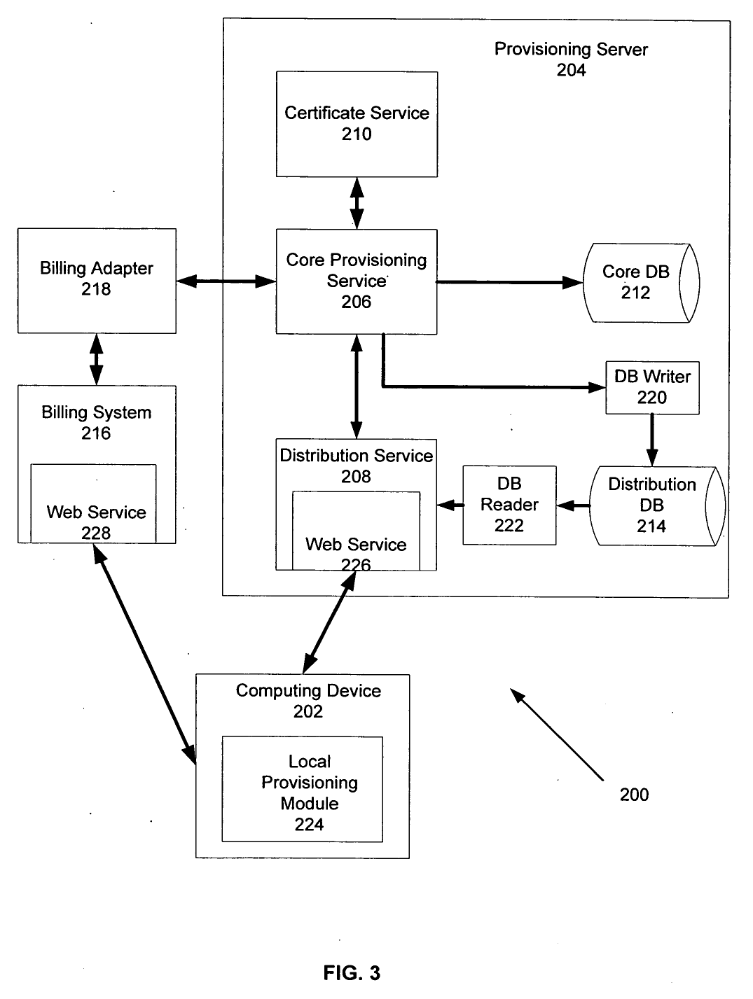

FIG. 3 illustrates a provisioning system 200 to provision usage of a resource on a computing device 202, wherein the computing device 202 may be any of the commonly known computing devices, such as the desktop computer 12, the laptop computer 22, the PDA 24, a cell phone, or any similar devices. The provisioning system 200 may be used to provision usage of other resources, such as software, a firmware, a feature of a computing device, etc. While the provisioning system 200 is shown to provision usage of a resource on the computing device 202 communicatively connected to the network 10, it may be used to implement such usage on another computing device that may not be connected to the network 10, or it may be only temporarily connected to the network 10.

The provisioning system 200 may include a provisioning server 204, having a core provisioning service module 206, a distribution service module 208, a certificate service module 210, a core database 212, and a distribution database 214. The provisioning server 204 may communicate with a billing system 216 via a billing adapter 218, whereas the core provisioning service module 206 may communicate with the distribution database 214 via a database writer 220 and the distribution database 214 communicates with the distribution service 208 via a database reader 222. The computing device 202 may include a local provisioning module (LPM) 224 that communicates with the distribution service module 208 via a distribution web service module 226 and to the billing system 216 via a billing web service module 228.

The provisioning server 204 may be located on a server system such as the server 30, or other system communicatively connected to the network 10. Similarly, the billing system 216 may also be located on server system such as the server 30, or other system communicatively connected to the network 10. Moreover, one or more of the various components of the provisioning server 204 may be located on a same server or on a number of different servers located in-different locations. For example, the core database 212 may be located on a number of different database servers located at different locations and each communicatively connected to the network 10. The functioning of the provisioning server 204 and its various component modules is explained in further detail below.

While in FIG. 3, the computing device 202 is shown to communicate with the distribution service module 208 and the billing system 216 via web service modules 226 and 228, respectively, in an alternate embodiment, a user of the computing device 202 may communicate with the distribution service module 208 and the billing system 216 via alternate modes of communication, such as telephone, etc. For example, in a situation, where it is not possible for the computing device 202 to connect to the network 10, a user of the computing device 202 may communicate via a telephone and a voice-recognition enabled user interface attached to the distribution service module 208, or via a customer service representative able to communicate with the distribution service module 208, etc.

When the computing device 202 is a computer such as the computer 110, the LPM 224 may be located on the non-removable non-volatile memory 140, as part of the system memory 130, as part of various hardware components of the computer 110, including the processing unit 120, or as any combination of these. The functioning of the LPM 224 is explained in further detail below. The provisioning server 204 may generate a provisioning packet and communicate the provisioning packet to the computing device 202 where the computing device 202 may validate and parse such a provisioning packet, in a manner disclosed in further detail below.

### XML Provisioning Schema

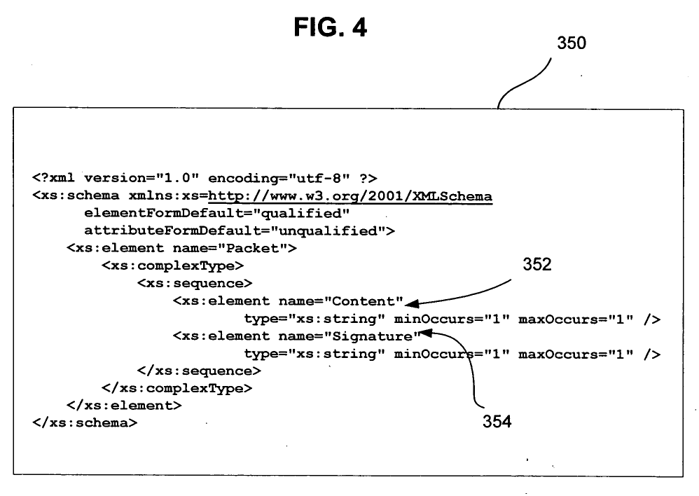

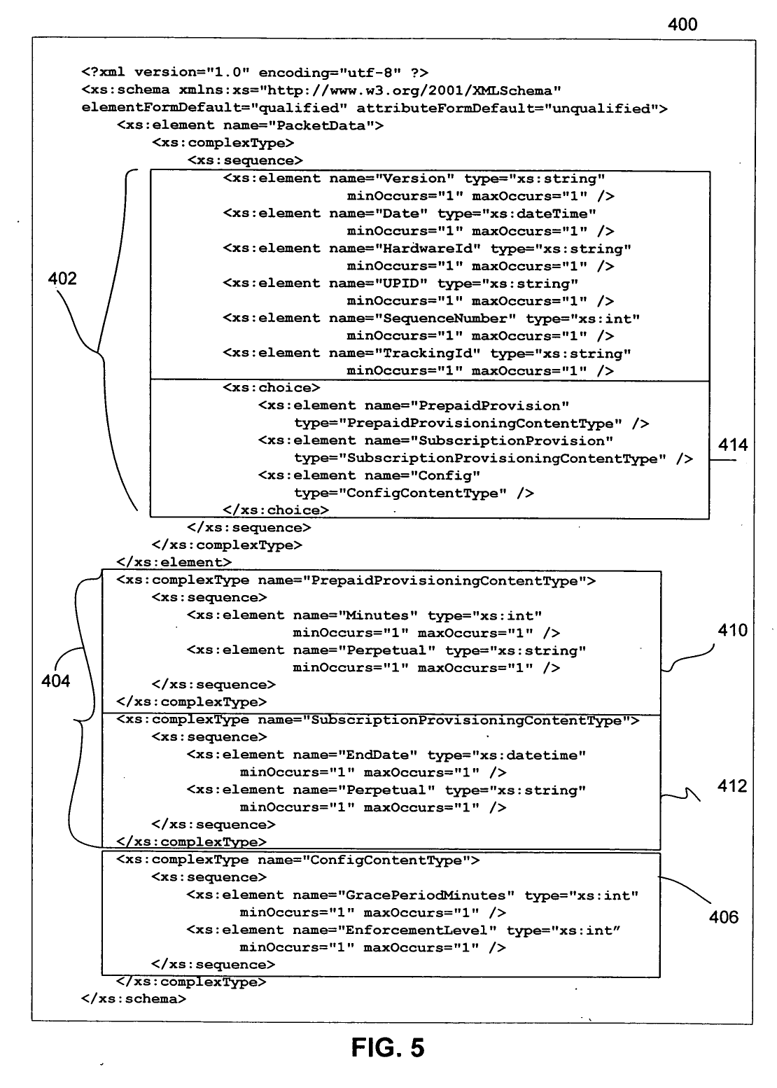

FIG. 4 is an illustration of an XML packet schema 350 that may be used to communicate between the provisioning server 204 and the computing device 202. The packet schema 350 includes at least two nodes, namely the content node 352 and the signature node 354. The content node 352 contains an actual provisioning/configuration packet, which is further described in detail in FIG. 5 below. The signature node 354 contains the signature of the content data contained in the content node 352.

The provisioning server 204 may generate an instance of an XML packet conforming to the XML packet schema 350 and communicate such an instance of the XML packet to the computing device 202. The provisioning server 204 generates the contents of the content node 354 using various provisioning and configuration information pertinent to the computing device 202, where such information may be provided by a core provisioning service (CPS) module 206, or other modules of the provisioning server 204. Additionally, the provisioning server 204 signs the instance of the XML packet using a signature derived from the signature service module 210. Such instance of the XML packets may be hosted by any of the web services 226-228.

The instance of such an XML packet may be communicated to the computing device 202 at the initiation of the provisioning server 204 either in response to requests received at the web services 226-228 or in any other manner. Once an instance of the provisioning packet is received by the computing device 202, for the computing device 224 to consume the provisioning packet, the LPM 224 has to validate the signature contained in the signature node 354. The LPM 224 may validate the signature using a key derived from a hard-coded trusted root, where such keys are hard-coded into LPM binary image. The LPM 224 also verifies that the root of the certificate chain is one of a plurality of hard-coded trusted roots and that the signer of the certificate is a trusted signer.

If the LPM 224 is able to validate the signature, it parses the content of the content node 352. However, if the LPM 224 is not able to validate the signature, the instance of the XML packet is discarded by the LPM.

FIG. 5 illustrates a provisioning schema 400 for the provisioning/configuration XML packet (hereinafter referred to as a provisioning XML packet). As illustrated above, The LPM 224 parses an instance of such a provisioning XML packet from the content node 352. A provisioning XML packet is mainly divided into three sections, a generic section 402, a specific section 404 and a configuration section 406. The generic section includes generic elements that are same for all provisioning XML packets, irrespective of whether a provisioning XML packet is for a pre-paid resource or for a subscription based resource. The specific section 404 contains two element blocks, a pre-paid element block 410 containing elements for pre-paid provisioning of resources and a subscription element block 412 containing elements for subscription based provisioning of resources.

Now referring to the generic section 402, it includes a plurality of generic elements, including, but not limited to the following:
Version: Used for compatibility reasons,
Date: UTC Date/Time on which this packet was created (in the server),
HardwareID: The Hardwareld of the system, for which this packet is destined for,
UPID: The Underwriter ID (Creator ID of the packet),
Sequence Number: This ID is used to prevent replay attacks., and is incremented by 1 for every packet generated by the server, and
TrackingID: This is used for tracking purposes.

The generic section 402 also includes a choice block 414 that specifies whether a particular provisioning packet is for pre-paid provisioning of the resources or for a subscription based provisioning of the resources.

On the other hand, the specific section 404 includes a pre-paid element block 410 and the subscription element block 412. The pre-paid element block 410 includes the fields of:
PrepaidProvision/Minutes: It's the time in minutes, and
PrepaidProvision/Perpectual: This field is set to “Yes” or “No”. This is set to “Yes”, if the system doesn't have to meter anymore. Otherwise, this field is set to “No”.

Whereas the subscription element block 412 includes the fields of:
SubscriptionProvision/Enddate: The expiry date and time of the system for normal use, after which the user has to purchase additional time to use the system, and
SubscriptionProvision/Perpetual: Same as PrepaidProvision/Perpetual.

Finally, the configuration section 406 includes the fields of:
Config/GracePeriodMinutes: This field (as in the current implementation) is relevant in both prepaid & subscription models. In the Prepaid model this field is used when a user has made a purchase, but a provisioning packet has not yet been downloaded. In the subscription model, this field is used when the subscription has expired, and
Config/EnforementLevel: This is a numeric field, which essentially changes ALL enforcement parameters with in LPM. This field is altered, based on the user's purchase pattern. This field is applicable to both prepaid and subscription models.

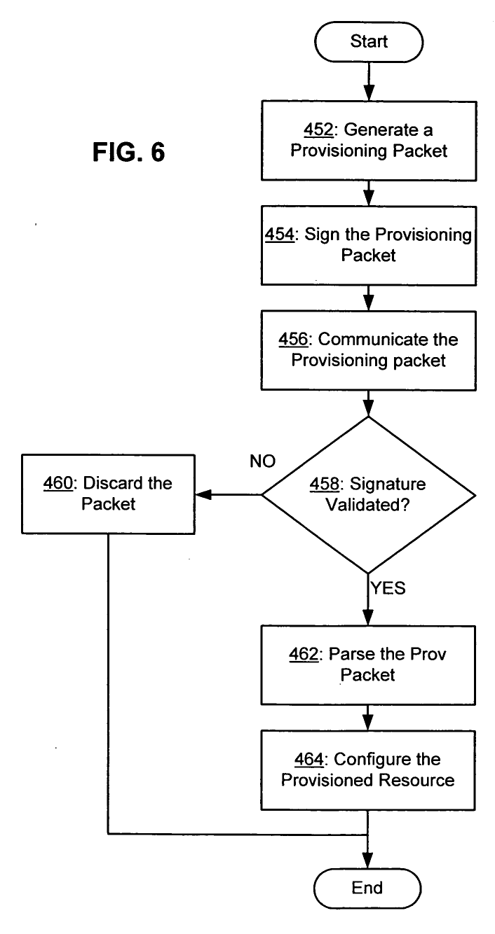

FIG. 6 illustrates a flowchart of a resource provisioning routine 450 using an XML provisioning Schema 300 for provisioning of a resource on a computer on the network. At a block 452 the provisioning server 204 generates a provisioning packet. Subsequently, at a block 454, the provisioning server 204 signs a provisioning packet using its public key and the certificate received from the certificate service module 210.

The signed provisioning packet is made available at the web service 226. At a block 456, in response to a request from the computing device 202, the signed provisioning packet is communicated to the computing device 202.

Upon receiving the signed provisioning packet, at a block 458 the computing device 202 validates the signature using the trusted root key hard-coded into the LPM binary image. In an embodiment of the XML provisioning packet 350 may contain a signature, the signature having a certificate chain starting from a signer's public key up to the signer's root public key. The block 458 may validate the signature of the XML provisioning packet 350 with a public key hard-coded in a local provisioning module of the computing device 202. Validating the signature of the content data may further include verifying that a root public key in a certificate chain in the signature is one from a set of hard-coded trusted root keys and verifying that the provisioning server signing the provisioning XML document is among a set of trusted signers.

If the LPM 224 is not able to validate the signature, at a block 460, the LPM 224 discards the signed provisioning packet, without parsing the content data at the CDATA tag of the signed provisioning packet.

However, if the LPM 224 is able to validate the signature, at a block 462, the LPM 224 parses the content data and recovers the various elements from the element blocks 402-412 described above with respect to FIG. 5. Using such elements from the provisioning packet, at a block 464 the LPM 224 configures and provisions a resource on the computing device 202.

As one of ordinary skill in the art would appreciate, not all the blocks of the resource provisioning routine 450 need to be performed for a given implementation of the resource provisioning routine 450. As some of the blocks of the resource provisioning routine 450 may be used primarily to increase the efficiency of the resource provisioning routine 450, one or more such blocks may be omitted in a given implementation without affecting the functionality of the resource provisioning routine 450. Moreover, one or more of the blocks in the resource provisioning routine 450 may also be implemented in an alternate order without affecting the functionality of the resource provisioning routine 450.

Although the forgoing text sets forth a detailed description of numerous different embodiments of the invention, it should be understood that the scope of the invention is defined by the words of the claims set forth at the end of this patent. The detailed description is to be construed as exemplary only and does not describe every possible embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

What is claimed is:

1. A method of provisioning a service on a client computer by using a provisioning XML (extensible markup language) document, wherein the provisioning XML document conforms to a provisioning XML schema comprising:
(a) a content node containing content data identifying the service to be provisioned on the client computer, and
(b) a signature node containing a signature of the content data; the method comprising:
(1) generating the provisioning XML document at a provisioning server;
(2) signing the provisioning XML document using a key derived from a trusted root; and
(3) communicating the provisioning XML document to the client computer.

2. A method of claim 1, further comprising configuring the service on the client computer by using the provisioning XML document.

3. A method of claim 2, wherein the content node further specifies at least one of: (1) an amount of prepaid time for which the service is to be provisioned; and (2) a subscription period expiry date through which the service is to be provisioned.

4. A method of claim 2, wherein the content node further specifies (1) a version of the provisioning XML document, (2) date of creation of the provisioning XML document, (3) time of creation of the provisioning XML document, (4) hardware identification of the client computer; (5) underwriter identification of the creator of the provisioning XML document; (6) a sequence number of the provisioning XML document; and (7) a tracking identification of the provisioning XML document.

5. A method of claim 2, wherein the content node further specifies a grace period for which the client computer is allowed to receive the provisioning XML document from the provisioning server.

6. A method of claim 2, wherein the content node further specifies an enforcement level for altering a plurality of enforcement parameters of the client computer.

7. A method of claim 2, wherein provisioning the service on the client computer further comprises:
validating the signature of the content data; and
parsing the content data if the signature of the content data is verified.

8. A method of claim 7, further comprising verifying the signature of the provisioning XML document with a public key hard-coded in a local provisioning module of the client computer.

9. A method of claim 7, wherein validating the signature of the content data further comprises:
verifying that a root public key in a certificate chain in the signature is one from a set of hard-coded trusted root keys; and
verifying that a provisioning server signing the provisioning XML document is among a set of trusted signers.

10. A data structure storing a provisioning XML (extensible markup language) document that conforms to a provisioning XML Schema, the data structure being stored in a data storage device for use by a provisioning server, wherein:
(1) the provisioning XML schema identifies the structure of the provisioning XML document;
(2) the provisioning XML document comprising:
(a) a content node containing content data identifying a service to be provisioned on a client computer, and
(b) a signature node containing a signature of the content data; and
(3) the provisioning XML document is signed using a key derived from a trusted root; and
(4) the provisioning XML document is communicated to the client computer with a public key of the provisioning server.

11. A data structure of claim 10, wherein the content node further specifies at least one of: (1) an amount of prepaid time for which the service is to be provisioned; and (2) a subscription period expiry date through which the service is to be provisioned.

12. A data structure of claim 10, wherein the content node further specifies (1) a version of the provisioning XML document, (2) date of creation of the provisioning XML document, (3) time of creation of the provisioning XML document, (4) hardware identification of the client computer; (5) underwriter identification of the creator of the provisioning XML document; (6) a sequence number of the provisioning XML document; and (7) a tracking identification of the provisioning XML document.

13. A data structure of claim 10, wherein the content node further specifies at least one of: (1) a grace period for which the client computer is allowed to receive the provisioning XML document from the provisioning server; (2) an enforcement level for altering a plurality of enforcement parameters of the client computer.

14. A service provisioning system for provisioning a service on a client computer, the service provisioning system comprising:
(1) a provisioning server including a processor, a communication module, a computer readable memory, and a provisioning XML document stored on the memory, the provisioning XML document including:
(a) a content node containing content data identifying a service to be provisioned on the client computer, and
(b) a signature node containing a signature of the content data;
the processor adapted to sign the provisioning XML document using a key derived from a trusted root;
the communication module adapted to communicate the provisioning XML document to the client computer; and
the client computer having: (1) a validation module adapted to validate the signature; and (2) a parsing module adapted to parse the content data.

15. A service provisioning system of claim 14, wherein the content node further specifies at least one of: (1) an amount of prepaid time for which the service is to be provisioned; and (2) a subscription period expiry date through which the service is to be provisioned.

16. A service provisioning system of claim 14, wherein the content node further specifies (1) a version of the provisioning XML document, (2) date of creation of the provisioning XML document, (3) time of creation of the provisioning XML document, (4) hardware identification of the client computer; (5) underwriter identification of the creator of the provisioning XML document; (6) a sequence number of the provisioning XML document; and (7) a tracking identification of the provisioning XML document.

17. A service provisioning system of claim 14, wherein the validation module is further adapted to verify that the key from the trusted root is one from a set of hard-coded trusted root keys; and that the provisioning server signing the provisioning XML document is among a set of trusted signers.

18. A service provisioning system of claim 14, wherein the content node further specifies at least one of: (1) a grace period for which the client computer is allowed to receive the provisioning XML document from the provisioning server; and (2) an enforcement level for altering a plurality of enforcement parameters of the client computer.

19. A service provisioning system of claim 14, wherein the provisioning server and the client computer are communicating with each other over the Internet.
